(19) United States
(12) Patent Application Publication
(10) Pub. No.: US 2005/0068350 A1
(43) Pub. Date: Mar. 31, 2005

(54) Management device for fluid path

(75) Inventor: Kenichi Okawa, Hachioji-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Olympus Corporation, Tokyo (JP)

(21) Appl. No.: 10/948,412

(22) Filed: Sep. 23, 2004

(30) Foreign Application Priority Data
Sep. 25, 2003 (JP) 2003-333803

(51) Int. Cl. B41J 2/195; B41J 2/175

(52) U.S. Cl. 347/7; 347/85

(57) ABSTRACT

When a fluid is supplied to a second container from a first container, a liquid surface sensor detects a change of a liquid surface height in the second container, a distinction section distinguishes an abnormal supply state of the fluid as at least two stages of abnormalities based on liquid surface height information of the detected fluid, and a distinction result is notified by a notification section.

### CROSS-REFERENCE TO RELATED APPLICATIONS

This application is based upon and claims the benefit of priority from prior Japanese Patent Application No. 2003-333803, filed Sep. 25, 2003, the entire contents of which are incorporated herein by reference.

### BACKGROUND OF THE INVENTION

1. Field of the Invention

The present invention relates to an image forming apparatus, for example, of an ink jet system, and to a management device for a fluid path, which manages a supply state of an ink liquid in an ink path for supplying the ink liquid stored in an ink bottle to an ink head through a reservoir tank and a distribution unit.

2. Description of the Related Art

In an image forming apparatus such as a printer, an ink liquid stored in an ink cartridge is supplied to an ink head (recording head unit). There is a possibility that an ink leakage occurs in an ink path from the ink cartridge to the ink head.

A technique of detecting the ink leakage is described, for example, in Jpn. Pat. Appln. KOKAI Publication No. 10-86357. In the Jpn. Pat. Appln. KOKAI Publication No. 10-86357, a carriage which reciprocates/operates for a recording operation is disposed, and the recording head unit is mounted on the carriage. The recording head unit and the carriage have substrates, respectively. A pair of electrodes for detecting the ink leakage are disposed on the substrate on a carriage side. The pair of electrodes for detecting the ink leakage have insulated states at a normal time. Detecting means for detecting a resistance value between the pair of electrodes for detecting the ink leakage is disposed. When the detecting means detects that the resistance value between the electrodes for detecting the ink leakage is smaller than a predetermined value, control means interrupts power supply on the side of the recording head unit. It is described that short-circuiting, fuming and the like are prevented from being caused between high-pressure electrodes for supplying a power to the recording head unit, and a warning of the ink leakage is given to a user.

### BRIEF SUMMARY OF THE INVENTION

According to a major aspect of the present invention, there is provided a management device for a fluid path, comprising: a first container which contains a fluid; a second container which contains the fluid; a fluid supply system which supplies the fluid to the second container from the fluid stored in the first container; a liquid surface sensor which detects a liquid surface height of the fluid stored in the second container and which outputs liquid surface information of the liquid surface height; a distinction section which distinguishes at least one of a supply state of the fluid into the second container including the fluid supply system, a state of the second container, or a drop of the liquid surface of the fluid based on the liquid surface information; and a notification section which issues a distinction result by the distinction section.

### BRIEF DESCRIPTION OF THE SEVERAL VIEWS OF THE DRAWING

FIG. 1 is a constitution diagram showing a first embodiment in a management device for a fluid path according to the present invention;

FIG. 2 is a management step diagram for the fluid path by the management device in a first embodiment;

FIG. 3 is a diagram showing a display example of a light degree of abnormality in the management device;

FIG. 4 is a diagram showing a display example of a serious degree of abnormality in the maintenance device;

FIG. 5 is a diagram showing a display example of a serviceman call in the management device;

FIG. 6 is a constitution diagram showing a second embodiment in the management device for the fluid path, which is applied to an image forming apparatus of an ink jet system according to the present invention;

FIG. 7 is a management step diagram for an ink path by the management device in a second embodiment;

FIG. 8 is a concrete constitution diagram of a notification driving section;

FIG. 9 is a diagram showing a notification example by a lamp in the management device;

FIG. 10 is a diagram showing a display driving program in the management device;

FIG. 11 is a diagram showing a display example by a display in the management device;

FIG. 12 is a diagram showing a display example by the display in the management device; and

FIG. 13 is a diagram showing a display example by the display in the management device.

### DETAILED DESCRIPTION OF THE INVENTION

A first embodiment of the present invention will be described hereinafter with reference to the drawings.

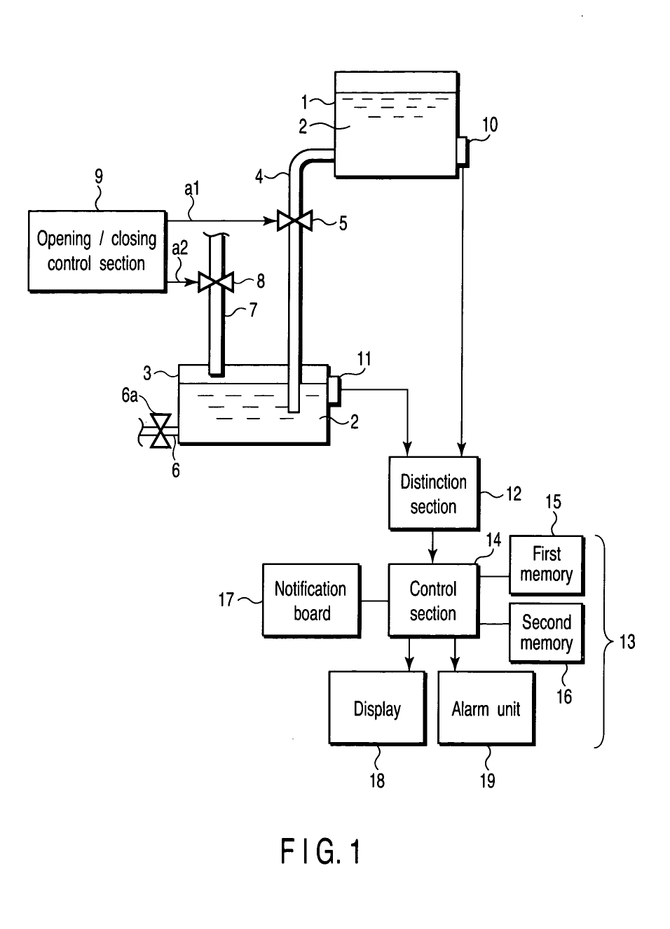

FIG. 1 is a constitution diagram of a management device for a fluid path. A first container 1 contains a fluid 2. The first container 1 is opened to the atmosphere. It is assumed that the fluid 2 is supplied to the first container 1 from the outside. Examples of the fluid 2 include all liquids such as water, ink liquid, drinking water, solution, liquefied gas, and petroleum.

A second container 3 is disposed under the first container 1. The second container 3 has an airtight structure. A piping 4 which is a fluid supply system is disposed between the first container 1 and the second container 3. One end of the piping 4 is connected to a side surface of the first container 1, and the other end thereof is soaked in the fluid 2 in the second container 3. The piping 4 is provided with a first opening/closing valve 5. Therefore, when the first opening/closing valve 5 is opened, the fluid 2 stored in the first container 1 is supplied to the second container 3 via the piping 4 and the first opening/closing valve 5 by a difference of elevation between the first container 1 and the second container 3.

A draining pipe 6 is disposed in a lower part of the second container 3. An atmosphere open tube 7 is disposed in an upper part of the second container 3. The atmosphere open tube 7 is provided with a second opening/closing valve 8. The second opening/closing valve 8 is opened, when the fluid 2 in the first container 1 is supplied into the second container 3.

The fluid 2 stored in the second container 3 is discharged to the outside from the draining pipe 6 having an opening/closing valve 6a, for example, when the second opening/closing valve 8 opens. The fluid 2 stored in the second container 3 is discharged to the outside from the draining pipe 6 because of a pressure rise in the second container 3 by the supply of the fluid 2 from the first container 1, when the opening/closing valve 6a opens.

An opening/closing control section 9 sends control signals a₁, a₂ for the opening or the closing to the first and second opening/closing valves 5, 8, respectively, to simultaneously open/control the first and second opening/closing valves 5, 8, when the fluid 2 stored in the first container 1 is supplied to the second container 3.

The first container 1 is provided with a first float switch 10 which is a liquid surface sensor. The first float switch 10 detects a liquid surface height of the fluid 2 stored in the first container 1. The first float switch 10 outputs a detection signal having a low level (hereinafter referred to as the L level), for example, when the liquid surface height in the first container 1 is not more than a first predetermined liquid surface height. The switch outputs a detection signal having a high level (hereinafter referred to as the H level), when the liquid surface height is not less than the first predetermined liquid surface height.

The second container 3 is provided with a second float switch 11 which is a liquid surface sensor. The second float switch 11 detects the liquid surface height of the fluid 2 stored in the second container 3. The second float switch 11 outputs a detection signal having a L level, for example, when the liquid surface height in the second container 3 is not more than a second predetermined liquid surface height. The switch outputs a detection signal having a H level, when the liquid surface height is not less than the second predetermined liquid surface height.

A distinction section 12 inputs the detection signal output from the first float switch 10, when the fluid is not discharged to the outside via the draining pipe 6. The section judges that a fluid leakage occurs in the first container 1, when the first opening/closing valve 5 is closed and the liquid surface height in the first container 1 is not more than the first predetermined liquid surface height.

The distinction section 12 inputs a detection signal output from the second float switch 11 to monitor a change in the liquid surface height in the second container 3 with an elapse of time in a first management step time T₁ when the first float switch 10 has the H level. As a result of the monitoring, the section judges that an abnormality is generated in the supply of the fluid 2 to the second container 3 from the first container 1, when the liquid surface height in the second container 3 drops below the second predetermined liquid surface height.

The distinction section 12 inputs a detection signal output from the second float switch 11 to monitor a change in the liquid surface height in the second container 3 with an elapse of time in a second management step time T₂. As a result of the monitoring, the section judges that an abnormality is generated in the second container 3, when the liquid surface height in the second container 3 drops below the second predetermined liquid surface height.

When the distinction section 12 judges that the abnormality is generated in the supply of the fluid 2 in one or both of the first and second management step times T₁ and T₂, the section distinguishes the abnormality in two divided stages: a first stage of abnormality in which the liquid surface height drops by consumption (the discharge to the outside by the draining pipe 6) of the fluid 2 stored in the second container 3; and a second stage of an abnormal supply state in which the fluid leakage occurs in a fluid path constituted of the first container 1, piping 4, and second container 3 or the path is clogged with the fluid.

Concretely, when the distinction section 12 inputs the detection signal output from the second float switch 11 to monitor the liquid surface height in the second container 3, the section distinguishes a light abnormality including that the liquid surface height drops by the usual discharge of the fluid 2 from the draining pipe 6 as the first stage of the abnormality.

The distinction section 12 inputs the detection signal output from the second float switch 11 to monitor the liquid surface height in the second container 3. As a result of the monitoring, when the liquid surface height does not rise, it is judged that an abnormal supply state is generated in the fluid path constituted of the first container 1 and the piping 4. Alternatively, even when the liquid surface height rises, the height drops within a predetermined time. In this case, it is judged that the leakage from the second container 3 is generated. The section distinguishes such serious degree of abnormality as the second stage of the abnormality.

A notification section 13 displays/outputs at least one of the drop of the liquid surface height distinguished as the light abnormality by the distinction section 12, and the generation of the abnormal supply state and the generation of the leakage as the serious abnormality.

The notification section 13 displays/outputs the generation of the abnormal supply state or the leakage in the fluid path, and also issues one or both of an alarm and a serviceman call indicating the generation of the abnormal supply state or the leakage.

Concretely, the notification section 13 has a control section 14 constituted of a CPU and the like. The control section 14 is connected to a first memory 15, a second memory 16, a notification board 17, a display 18 for displaying the abnormality, and an alarm unit 19.

In the first memory 15, a plurality of notification items are stored having character information indicating “the abnormality in the fluid path between the first and second containers” which is the serious abnormality, and character information of “serviceman call”. It is to be noted that the first memory 15 may store the character information in “the drop of the liquid surface height in the second container” which is the light abnormality.

In the second memory 16, a display driving program is stored for reading the notification item of the serious abnormality stored in the first memory 15 to display/output the item in the liquid crystal display 18.

In the display board 17, as shown in FIG. 3, a plurality of display lamps 21-1 to 21-n are disposed on a display item board 20. For example, “the drop of the liquid surface in the second container” is described as the notification item on the display item board 20. The respective display lamps 21-1 to 21-n are disposed in positions corresponding to the respective notification items. The respective display lamps 21-1 to 21-n have, for example, lamps or light emitting diodes.

The display 18 has, for example, a liquid crystal display, a plasma display, or a CRT display.

The alarm unit 19 has, for example, a buzzer.

When the distinction section 12 distinguishes the generation of the light abnormality in the drop of the liquid surface height in the second container 3, the control section 14 lights, for example, the display lamp 21-1 in the display board 17.

The distinction section 12 distinguishes, for example, the generation of the abnormal supply state of the fluid 2 in the second container 3 which is the serious abnormality, and then the control section 14 executes the display driving program stored in the second memory 16, and reads the character information of “the abnormality in the fluid path between the first and second containers” stored in the first memory 15 to display/output the information in the display 18.

The generation of the abnormal supply state of the fluid 2 in the second container 3 is distinguished as the serious abnormality, and then the control section 14 reads the character information of “the serviceman call” stored in the first memory 15 to display/output the information in the display 18.

On distinguishing, for example, the generation of the abnormal supply state of the fluid 2 in the second container 3 as the serious abnormality, the control section 14 rings the alarm unit 19.

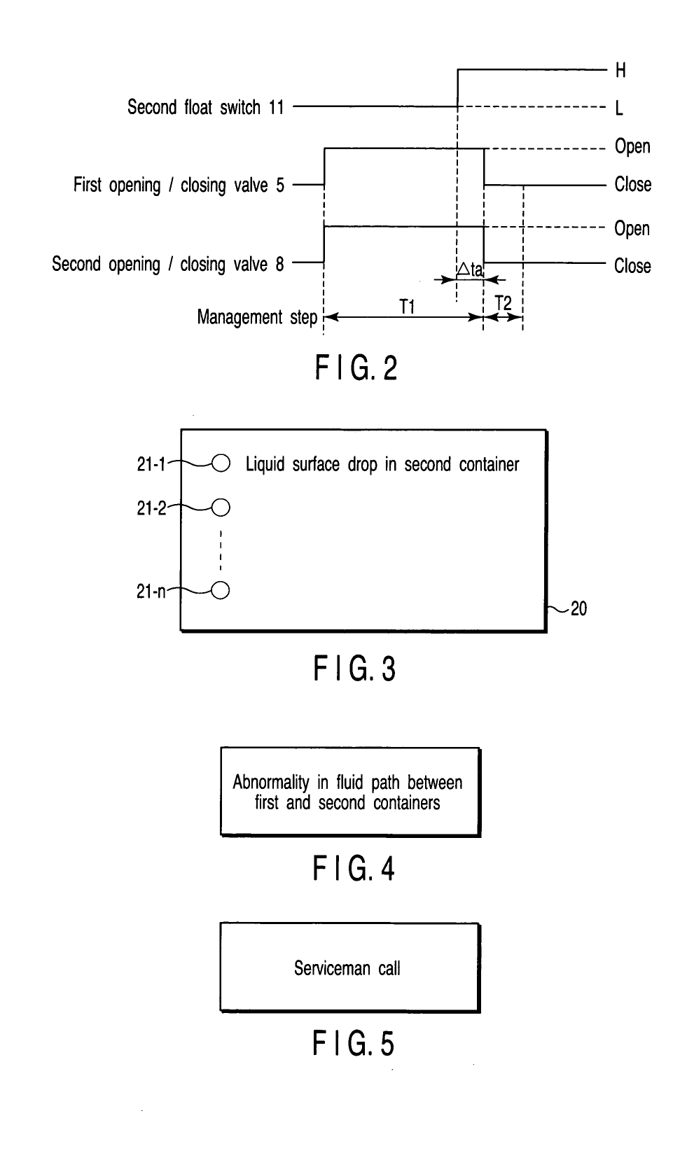

Next, a management operation of the fluid path by the management device constituted as described above will be described with reference to a management step diagram for the fluid path, shown in FIG. 2.

The opening/closing control section 9 sends the opening control signals a₁, a₂ to the first and second opening/closing valves 5, 8 at the start of the preset first management step time T₁. The first and second opening/closing valves 5, 8 are simultaneously opened in the first management step time T₁. Accordingly, the fluid 2 stored in the first container 1 is supplied to the second container 3 through the piping 4. The liquid surface height of the fluid 2 in the second container 3 gradually rises by the supply of the fluid 2.

The second float switch 11 outputs the L-level detection signal, when the liquid surface height of the fluid 2 stored in the second container 3 is not more than the second predetermined liquid surface height. When the liquid surface height of the fluid 2 reaches and exceeds the second predetermined liquid surface height, the second float switch 11 outputs the H-level detection signal.

As a result of the monitoring of the change of the liquid surface height with an elapse of time in the first management step time T₁, when the liquid surface height in the second container 3 drops below the second predetermined liquid surface height, the distinction section 12 judges that the abnormality is generated in the supply of the fluid 2 from the first container 1 to the second container 3.

Next, the distinction of the abnormality will be concretely described.

As a result of the monitoring of the liquid surface height in the second container 3, when the height does not reach the second predetermined liquid surface height, the distinction section 12 judges that the liquid surface height drops by the discharge of the fluid 2 from the draining pipe 6, which is the light abnormality.

The distinction section 12 sends the distinction result indicating the drop of the liquid surface height, which is the light abnormality, to the notification section 13.

On receiving the distinction result of the distinction section 12, the control section 14 of the notification section 13 lights, for example, the display lamp 21-1 in the display board 17 shown in FIG. 3, corresponding to the drop of the liquid surface height, which is the light abnormality.

Moreover, as a result of the monitoring of the liquid surface height in the second container 3 with the elapse of time, when the liquid surface height does not rise, the distinction section 12 judges that the abnormal supply state of the fluid 2 is generated in the fluid path constituted of the first container 1 and piping 4. When the liquid surface height rises, but when the height lowers within a predetermined time, the distinction section 12 judges that the leakage is generated in the second container 3, which is the serious abnormality.

The distinction section 12 sends the distinction result in the serious abnormality that the abnormal supply state of the fluid 2 is generated in the fluid path or that the leakage is generated in the second container 3 to the notification section 13.

On receiving the distinction result of the distinction section 12, the control section 14 of the notification section 13 executes the display driving program stored in the second memory 16 and corresponding, for example, to the generation of the abnormal supply state of the fluid 2.

The control section 14 executes the display driving program, reads the character information indicating “the abnormality in the fluid path between the first and second containers” stored in the first memory 15, and displays/outputs the information in the display 18 as shown in FIG. 4.

Moreover, the control section 14 reads the character information of “the serviceman call” stored in the first memory 15, and displays/outputs the information in the display 18 as shown in FIG. 5. When the generation of the serious abnormality is distinguished, the control section 14 rings the alarm unit 19.

Next, after an elapse of a delay time Ata from when the liquid surface height in the second container 3 reaches the second predetermined liquid surface height, and the H-level detection signal is output from the second float switch 11, the opening/closing control section 9 sends the closing control signals a₁, a₂ to the first and second opening/closing valves 5, 8, respectively.

The first and second opening/closing valves 5, 8 close simultaneously with the start of the second management step time T₂. Accordingly, the supply of the fluid 2 from the first container 1 to the second container 3 stops.

The second management step time T₂ starts after the elapse of the delay time Ata for the following reason.

Immediately after the detection signal output from the second float switch 11 changes to the H level, the supply of the fluid 2 from the first container 1 into the second container 3 stops, and then an erroneous operation by detection of a liquid surface height fluctuation in the second container 3 during the supply of the fluid 2 is assumed. Then, the supply continues with the delay time Δta until the second float switch 11 securely turns to the H level.

As described above, according to the first embodiment, when the fluid 2 is supplied to the second container 3 from the first container 1, the change of the liquid surface height in the fluid 2 in the second container 3 is detected by the second float switch 11, and the abnormality of the supply state of the fluid 2 is distinguished in at least two stages of the abnormalities by the distinction section 12 based on the liquid surface height information in at least the detected fluid 2. The distinction result is notified to at least the display board 17 or display 18 by the notification section 13.

Accordingly, the supply state during the supply of the fluid 2 from the first container 1 to the second container 3, or the leakage of the fluid 2 in the second container 3 can be distinguished.

For example, the light abnormality indicating that the liquid surface height drops by the usual discharge of the fluid 2 from the draining pipe 6, and the serious abnormality indicating that the abnormal supply state of the fluid 2 is generated in the fluid path constituted of the first container 1 and piping 4 or that the leakage of the fluid 2 is generated in the second container 3 can be distinguished.

When the serious abnormality is generated, the character information of “the serviceman call” is displayed/output in the display 18, and the alarm unit 19 can be rung.

A user can take measures in accordance with the light and serious abnormalities.

The user can recognize the generation of the serious abnormality by the display/output of “the serviceman call” and the ringing of the alarm unit 19.

Next, a second embodiment of the present invention will be described with reference to the drawings.

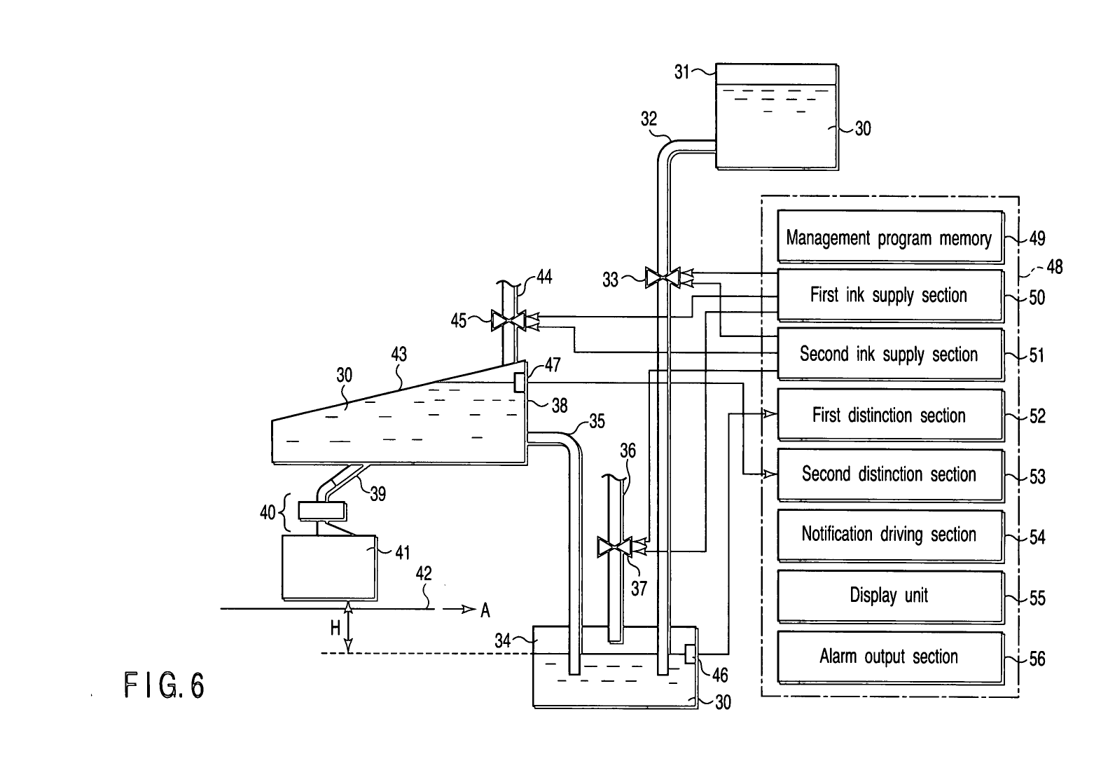

FIG. 6 is a constitution diagram in a management device for a fluid path, which is applied to an image forming apparatus of an ink jet system.

The image forming apparatus of the ink jet system has a plurality of ink bottles 31 which contain ink liquids 30 of black (K), cyan (C), magenta (M), and yellow (Y) colors. FIG. 1 shows one ink path for the one-color ink liquid 30, and shows one ink bottle 31 disposed in one ink path.

A first ink path tube 32 which is a first piping is disposed in a bottom part of the ink bottle 31. The ink path tube 32 is curved halfway and extended downwards. The first ink path tube 32 is provided with a first opening/closing valve 33.

A reservoir tank 34 is disposed under the ink bottle 31. The reservoir tank 34 has an airtight structure. A lower end of the first ink path tube 32 is soaked in the ink liquid 30 in the reservoir tank 34. Therefore, when the first opening/closing valve 33 is opened, the ink liquid 30 stored in the ink bottle 31 is supplied to the reservoir tank 34 through the first ink path tube 32 by a difference of elevation between the ink bottle 31 and the reservoir tank 34.

The reservoir tank 34 is provided with a second ink supply tube 35 which is a second piping. The second ink supply tube 35 is extended upward from the reservoir tank 34. The lower end (suction port) of the second ink supply tube 35 is soaked in the ink liquid 30 in the reservoir tank 34.

An atmosphere open tube 36 which is a third piping is extended upward from the reservoir tank 34. The lower end of the atmosphere open tube 36 is extended into atmospheric ambience formed in the reservoir tank 34. The atmosphere open tube 36 is provided with an atmosphere open valve 37 which is a second opening/closing valve.

A distribution unit 38 is disposed in a height position between the ink bottle 31 and the reservoir tank 34. An ink head 41 is disposed in the lower part of the distribution unit 38 via an ink inflow channel 39 and a sealing mechanism 40 of the ink flow path.

The ink head 41 has an ink jet system. The ink head 41 is fixed. A plurality of ink nozzles which eject the ink liquids 30 are arranged in the lower surface of the ink head 41.

The ink head 41 ejects the ink liquid 30. An image forming medium 42 is conveyed in an arrow A direction under the ink head 41 at a constant speed. The ink liquid 30 ejected from the ink head 41 is shot on the image forming medium 42. Accordingly, an image is formed on the image forming medium 42.

A height position of the lower surface of the ink head 41 is disposed to be higher than the liquid surface height of the ink liquid 30 in the reservoir tank 34 by a height H. A plurality of ink heads 41 are connected to the distribution unit 38. FIG. 6 shows one ink head 41. If a plurality of ink heads 41 are shown, the drawing is complicated.

An upper surface 43 of the distribution unit 38 tilts with respect to a horizontal direction. An atmosphere open tube 44 is disposed in the upper part of the upper surface 43 of the distribution unit 38. The atmosphere open tube 44 is provided with an atmosphere open valve 45 which is a third opening/closing valve.

A first float switch 46 which is a first liquid surface sensor is disposed on an inner wall of the reservoir tank 34. The first float switch 46 detects the liquid surface height of the ink liquid 30 stored in the reservoir tank 34, and outputs a detection signal having a low level (hereinafter referred to as the L level), when the liquid surface height is not more than a preset first predetermined liquid surface height. The first float switch 46 detects the liquid surface height of the ink liquid 30 stored in the reservoir tank 34, and outputs a detection signal having a high level (hereinafter referred to as the H level), when the liquid surface height reaches and exceeds a preset first predetermined liquid surface height.

A second float switch 47 which is a second liquid surface sensor is disposed on an inner wall of the distribution unit 38. The second float switch 47 detects the liquid surface height of the ink liquid 30 stored in the distribution unit 38, and outputs a detection signal having a low level (hereinafter referred to as the L level), when the liquid surface height is not more than a preset second predetermined liquid surface height. The second float switch 47 detects the liquid surface height of the ink liquid 30 stored in the distribution unit 38, and outputs a detection signal having a high level (hereinafter referred to as the H level), when the liquid surface height reaches and exceeds a preset second predetermined liquid surface height.

A step management device 48 executes a step management program stored beforehand, accordingly inputs detection signals output from the first and second float switches 46, 47, distinguishes ink supply states in at least the reservoir tank 34 and distribution unit 38 based on liquid surface height information of the ink liquids 30 in the reservoir tank 34 and distribution unit 38, and notifies the user of the distinction result.

The step management device 48 has a management program memory 49, a first ink supply section 50, a second ink supply section 51, a first distinction section 52, a second distinction section 53, a notification driving section 54, a display unit 55, and an alarm output section 56.

A step management program is stored in the management program memory 49.

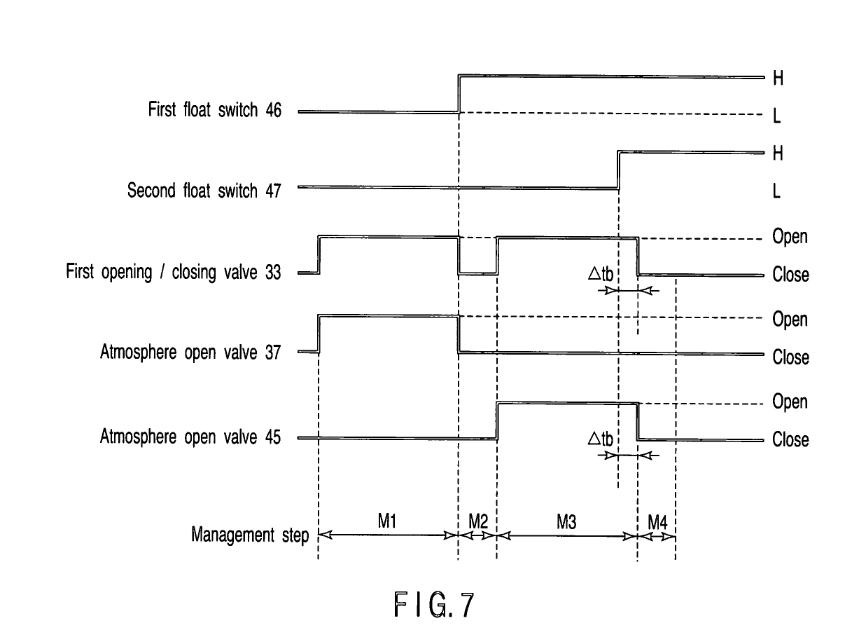

As shown in FIG. 7, in a preset first management step time M₁, the first ink supply section 50 opens the first opening/closing valve 33 and the atmosphere open tube 37, and further closes the atmosphere open valve 45 to supply the ink liquid 30 stored in the ink bottle 31 to the reservoir tank 34.

In a third management step time M₃, the second ink supply section 51 opens the first opening/closing valve 33 and the atmosphere open tube 45, and further closes the atmosphere open valve 37 to supply the ink liquid 30 stored in the reservoir tank 34 to the distribution unit 38.

After an elapse of a delay time Δtb from when the H-level detection signal is output from the second float switch 47, the second ink supply section 51 sends closing control signals to the first opening/closing valve 33 and the atmosphere open valve 45, respectively.

A fourth management step time M₄ starts after the elapse of the delay time Δtb for the following reason.

Immediately after the detection signal output from the second float switch 47 changes to the H level, the supply of the ink liquid 30 from the reservoir tank 34 into the distribution unit 38 stops, and then an erroneous operation by detection of a liquid surface height fluctuation in the distribution unit 38 during the supply of the ink liquid 30 or a reverse flow of the ink liquid 30 from the distribution unit 38 toward the reservoir tank 34 is assumed. Then, the supply continues with the delay time Δtb until the second float switch 47 securely turns to the H level.

The first distinction section 52 judges whether or not the detection signal output from the first float switch 46 changes to the H level during the elapse of the first management step time M₁ when the ink liquid 30 is supplied through the ink path between the ink bottle 31 and the reservoir tank 34. On judging that the detection signal output from the first float switch 46 changes to the H level during the elapse of the first management step time M₁, the first distinction section 52 judges that the supply of the ink liquid 30 from the ink bottle 31 into the reservoir tank 34 is completed. On judging that the supply of the ink liquid 30 is completed, the first distinction section 52 judges that there is not any abnormal supply state such as leakage of the ink liquid 30 or clogging therewith in the ink path between the ink bottle 31 and the reservoir tank 34. When the detection signal output from the first float switch 46 does not change to the H level, it is judged that the abnormal supply state is generated.

The first distinction section 52 monitors whether or not the detection signal output from the first float switch 46 is maintained at the H level with the elapse of time in a second management step time M₂. As a result of the monitoring for the time, for example, when the detection signal of the first float switch 46 changes to the L level, it is judged that the leakage of the ink liquid 30 is generated in the reservoir tank 34.

In the second management step time M₂ in the first distinction section 52, for example, it is possible to detect the leakage of the ink liquid 30 in a case where a leakage amount of the ink liquid 30 by the reservoir tank 34 is smaller than a supply amount of the ink liquid 30 supplied from the ink bottle 31.

As described above, when there is the leakage of or the clogging with the ink liquid 30 in the ink path between the ink bottle 31 and the reservoir tank 34, or the leakage in an abnormal state of the reservoir tank 34, the first distinction section 52 distinguishes the abnormality before the supply of the ink liquid 30 from the reservoir tank 34 into the distribution unit 38.

Concretely, distinction of the abnormality by the first distinction section 52 will be described.

As a result of monitoring of the liquid surface height in the reservoir tank 34, when the height does not reach a first predetermined liquid surface height (the detection signal output from the first float switch 46 changes to the H level), the first distinction section 52 distinguishes the light abnormality by the drop of the liquid surface height in the reservoir tank 34 by consumption of the ink liquid 30 at the time of an image forming operation.

The first float switch 46 does not change to the H level during the elapse of the first management step time M₁ when the image forming operation is not performed. Then, the first distinction section 52 distinguishes the serious abnormality that the leakage of or the clogging with the ink liquid 30 is generated in the ink path between the ink bottle 31 and the reservoir tank 34.

The H level output from the first float switch 46 is not maintained during the elapse of the second management step time M₂ when the image forming operation is performed after the elapse of the first management step time M₁. Then, the first distinction section 52 distinguishes the serious abnormality indicating that the leakage of the ink liquid 30 is generated in the reservoir tank 34.

As a result of the monitoring of the liquid surface height in the distribution unit 38, when the height does not reach the second predetermined liquid surface height (the detection signal output from the second float switch 47 changes to the H level), the second distinction section 53 distinguishes the light abnormality by the drop of the liquid surface height in the distribution unit 38 by the consumption of the ink liquid 30 at the time of the image forming operation.

The detection signal output from the second float switch 47 does not change to the H level during the elapse of the third management step time M₃ when the image forming operation is not performed. Then, the second distinction section 53 distinguishes indicating that the leakage of or the clogging with the ink liquid 30 is generated in the ink path between the reservoir tank 34 and the distribution unit 38.

The image forming operation is not performed after the elapse of the third management step time M₃, the detection signal output from the second float switch 47 is not maintained at the H level during the elapse of a fourth management step time M₄. Then, the second distinction section 53 distinguishes the serious abnormality indicating that the leakage of the ink liquid 30 is generated in the distribution unit 38.

In the fourth management step time M₄ in the second distinction section 53, it is possible to detect the leakage of the ink liquid 30 in a case where, for example, a leakage amount of the ink liquid 30 by the distribution unit 38 is smaller than a supply amount of the ink liquid 30 supplied from the reservoir tank 34.

As described above, for example, the abnormality by the leakage of or the clogging with the ink liquid 30 in the ink path between the reservoir tank 34 and the distribution unit 38, or the abnormality by the leakage of the ink liquid 30 in the distribution unit 38 can be distinguished.

Concretely, the distinction of the abnormality by the second distinction section 53 will be described.

As a result of the monitoring of the liquid surface height in the distribution unit 38, when the liquid surface height in the distribution unit 38 does not reach the second predetermined liquid surface height, the second distinction section 53 distinguishes the light abnormality by the drop of the liquid surface height in the distribution unit 38 by the consumption of the ink liquid 30 at the time of the image forming operation.

As a result of the monitoring of the liquid surface height in the distribution unit 38 with the elapse of time, when the liquid surface height does not rise, or when the liquid surface height rises but lowers within a predetermined time, the second distinction section 53 distinguishes the serious abnormality indicating the leakage of or the clogging with the ink liquid 30 in the ink path between the reservoir tank 34 and the distribution unit 38, or the leakage generated in the distribution unit 38.

On receiving the distinction results of the first and second distinction sections 52 and 53, the notification driving section 54 drives the display unit 55 in order to display the light abnormality by the drop of the ink surface height in the reservoir tank 34 and distribution unit 38 by the consumption of the ink liquid 30 at the time of the image forming operation.

On receiving the distinction result of the first distinction section 52, the notification driving section 54 allows the alarm output section 56 to output an alarm indicating the serious abnormality by the generation of the leakage of or the clogging with the ink liquid 30 in the ink path tube 32 or the reservoir tank 34, or allows the display unit 55 to display the serviceman call.

On receiving the distinction result of the second distinction section 53, the notification driving section 54 allows the alarm output section 56 to output an alarm indicating, for example, the serious abnormality by the generation of the leakage of or the clogging with the ink liquid 30 in the ink supply tube 35, or the leakage of the ink liquid 30 in the distribution unit 38, or allows the display unit 55 to display the serviceman call.

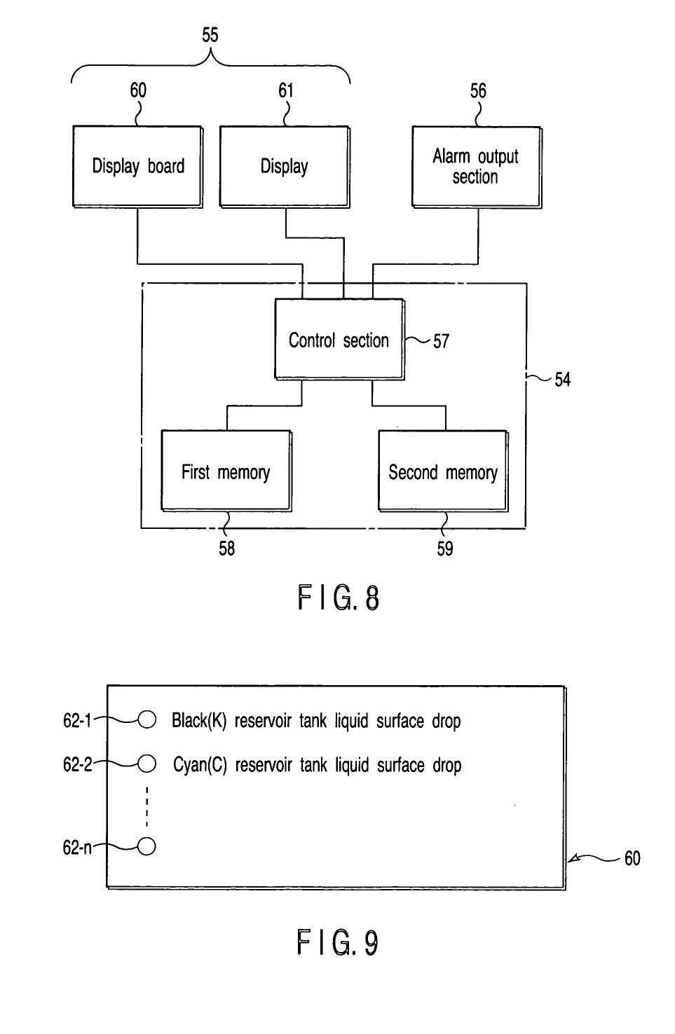

A concrete constitution of the notification driving section 54 will be described with reference to FIG. 8.

The notification driving section 54 has a control section 57 constituted of a CPU or the like. The control section 57 is connected to a first memory 58, a second memory 59, the display unit 55, and the alarm output section 56. The display unit 55 has a display board 60 and a display 61 for displaying the abnormality. The alarm output section 56 has an alarm unit such as a buzzer.

As shown in FIG. 9, in the display board 60, a plurality of display lamps 62-1 to 62-n are arranged on the display item plate 61. On the display item plate 61, as the notification items, the light abnormalities are described, for example, “liquid surface drop of the reservoir tank of black (K)” and “liquid surface drop of the reservoir tank of cyan (C)”. The respective display lamps 62-1 to 62-n are disposed in positions corresponding to the respective notification items. The display lamps 62-1 to 62-n have, for example, lamps or light emitting diodes.

The display 61 has, for example, a liquid crystal display, a plasma display, or a CRT display.

The first memory 58 stores character information indicating the serious abnormalities, for example, “the abnormality of the ink path between the ink bottle and reservoir tank of black (K)” and “the abnormality of the ink path between the reservoir tank and distribution unit of black (K)”, and a plurality of notification items having character information indicating “the serviceman call”.

It is to be noted that in the first memory 58, character information indicating the light abnormality “the liquid surface drop in the reservoir tank of black (K)” may be stored.

The second memory 59 stores a display driving program P for reading one of the notification items indicating the serious abnormalities stored in the first memory 58 to display/output the character information of each notification item indicating the serious abnormality in the display 61.

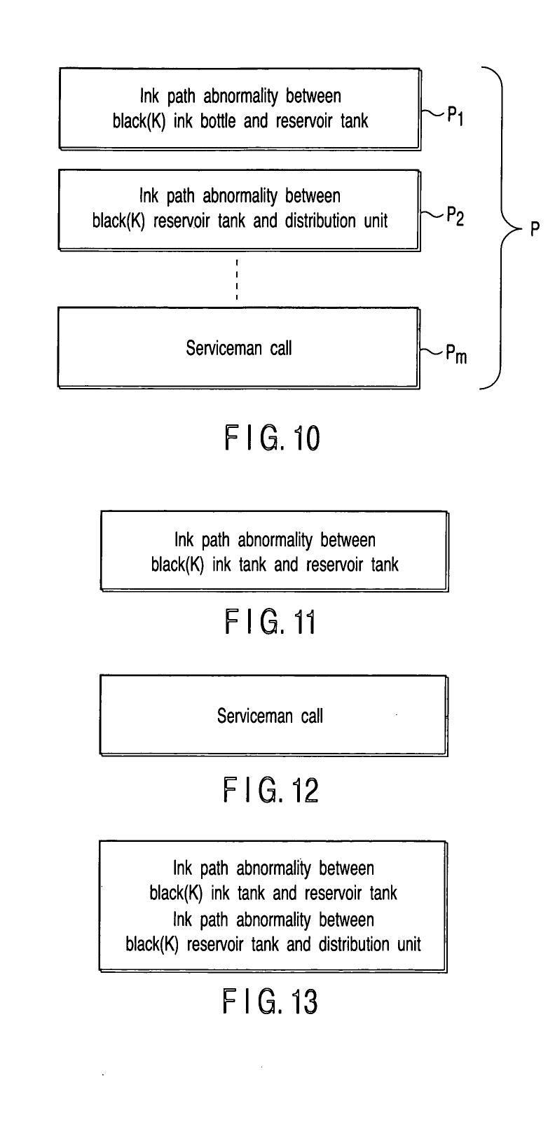

As shown in FIG. 10, the display driving program P has a plurality of programs P₁ to Pₘ corresponding to the notification items in the serious abnormality. The program P₁ has display contents for allowing the display 61 to display/output “the abnormality of the ink path between the ink bottle and reservoir tank of black (K)”. The program P₂ has display contents for allowing the display 61 to display/output “the abnormality of the ink path between the reservoir tank and distribution unit of black (K)”. The program Pₘ has display contents for allowing the display 61 to display/output “the serviceman call”.

The control section 57 lights, for example, the display lamp 62-1 in the display board 60, corresponding to the generation item of the light abnormality by the drop of the liquid surface height in one or both of the reservoir tank 34 and the distribution unit 38 by the first and second distinction sections 52, 53.

The first and second distinction sections 52, 53 distinguish the serious abnormality indicating the generation of the leakage of or the clogging with the ink liquid 30 at the time of one or both of supply of the ink liquid 30 in the ink path between the ink bottle 31 and the reservoir tank 34 and the supply of the ink liquid 30 in the ink path between the reservoir tank 34 and the distribution unit 38. Then, the control section 57 executes, for example, the corresponding program P₁ among the respective programs P₁ to Pₘ stored in the second memory 59.

Accordingly, the control section 57 reads, for example, the character information indicating “the abnormality of the ink path between the ink bottle and reservoir tank of black (K)” stored in the first memory 58, and displays/outputs the information in the display 61.

When the first and second distinction sections 52, 53 distinguish the serious abnormality, for example, “the abnormality of the ink path between the ink bottle 31 and reservoir tank of black (K)”, the control section 57 reads the character information of “the serviceman call” stored in the first memory 58 to display/output the information in the display 61.

When the first and second distinction sections 52, 53 distinguish the serious abnormality, for example, “the abnormality of the ink path between the ink bottle and reservoir tank of black (K)”, the control section 57 rings the alarm output section 56.

On receiving the distinction results of the first and second distinction sections 52, 53, the notification driving section 54 notifies the results in accordance with the light and serious abnormalities. The light abnormalities include the drop of the ink surface height in the reservoir tank 34 by the consumption of the ink liquid 30 at the time of the image forming operation, and the drop of the ink surface height in the distribution unit 38 by the consumption of the ink liquid 30 at the time of the image forming operation.

The serious abnormalities include: a case where the leakage of or the clogging with the ink liquid 30 is generated in the ink path between the ink bottle 31 and the reservoir tank 34; a case where the leakage of or the clogging with the ink liquid 30 is generated in the ink path between the reservoir tank 34 and the distribution unit 38; and a case where the leakage of the ink liquid 30 is generated in one or both of the reservoir tank 34 and the distribution unit 38.

Next, a case where the distinction result in the light abnormality is notified to the notification driving section 54 from the first and second distinction sections 52, 53 will be described.

On receiving the notification of the distinction result in the drop of the ink surface height in the reservoir tank 34 by the consumption of the ink liquid 30 of black (K) at the time of the image forming operation, the notification driving section 54 lights the display lamp 62-1 corresponding to the notification item “black (K) reservoir tank liquid surface drop” on the display item plate 61 as shown in FIG. 9. In this case, the display lamp 62-1 may continuously light or blink by the notification driving section 54.

On receiving the notification of the distinction result indicating the drop of the ink surface height in the reservoir tank 34 by the consumption of the ink liquids 30 of black (K) and cyan (C), the control section 57 of the notification driving section 54 simultaneously lights the respective display lamps 62-1, 62-2.

Next, a case where the distinction result in the serious abnormality is notified to the notification driving section 54 from the first and second distinction sections 52, 53 will be described.

On receiving the notification of the distinction result indicating the generation of the leakage of or the clogging with the ink liquid 30 in the ink path between the ink bottle 31 and the reservoir tank 34, for example, of black (K), the control section 57 of the notification driving section 54 executes the display driving program P₁ corresponding to the generation of the leakage of or the clogging with the ink liquid 30 in the ink path between the ink bottle 31 and the reservoir tank 34 of black (K) stored in the second memory 59.

The control section 57 reads the character information indicating “the ink path abnormality between the ink bottle and reservoir tank of black (K)” stored in the first memory 58 by the execution of the display driving program P₁, and displays/outputs the information in the display 61 as shown in FIG. 11.

Moreover, the control section 57 reads the character information of “the serviceman call” stored in the first memory 58, and displays/outputs the information as shown in FIG. 12. Since the control section 57 distinguishes the generation of the serious abnormality, the section rings the alarm unit of the alarm output section 56.

For example, on receiving the distinction results indicating the generation of the leakage of or the clogging with the ink liquids 30 in the ink paths between the ink bottle 31 and the reservoir tank 34 of black (K) and between the reservoir tank 34 and the distribution unit 38 of black (K), the control section 57 of the notification driving section 54 executes the display driving programs P₁, P₂ corresponding to “the generation of the leakage of or the clogging with the ink liquid 30 in the ink path between the ink bottle 31 and the reservoir tank 34 of black (K)” and “the generation of the leakage of or the clogging with the ink liquid 30 in the ink path between the reservoir tank 34 and the distribution unit 38 of black (K)” stored in the second memory 59.

The control section 57 executes the display driving programs P₁, P₂ to thereby read the character information indicating “the ink path abnormality between the black (K) ink bottle 31 and reservoir tank 34” and “the ink path abnormality between the black (K) reservoir tank 34 and distribution unit 38” stored in the first memory 58, and displays/outputs the information in the display 61 as shown in FIG. 13.

Moreover, the control section 57 reads the character information of “the serviceman call” stored in the first memory 15, and displays/outputs the information in the display 18 as shown in FIG. 12.

Moreover, the control section 57 rings the alarm unit of the alarm output section 56 in accordance with the distinction result in the generation of the serious abnormality.

As described above, according to the second embodiment, when the ink liquid 30 stored in the ink bottle 31 is supplied to the reservoir tank 34, the supply state of the ink liquid 30 between the ink bottle 31 and the reservoir tank 34, the leakage of the reservoir tank 34 and the like can be distinguished based on the liquid surface height information of the ink liquid 30 in the reservoir tank 34.

When the ink liquid 30 stored in the reservoir tank 34 is supplied to the distribution unit 38, the supply state of the ink liquid 30 between the reservoir tank 34 and the distribution unit 38, the leakage of the distribution unit 38 and the like can be distinguished based on the liquid surface height of the ink liquid 30 in the distribution unit 38.

As described above, the generation of the abnormality in the supply state of the ink liquid 30 to one or both of the reservoir tank 34 and the distribution unit 38, and the generation of the abnormality of the state in the reservoir tank 34 or the distribution unit 38 are displayed/output in the display unit 55, or alarmed by the alarm output section 56 based on the respective distinction results.

For example, when the leakage of the ink liquid 30 is generated, it can be displayed/output with respect to a user whether a place of the generation of the leakage of the ink liquid 30 is, for example, “between the ink path tube 32 and the reservoir tank 34” or “between the ink path tube 35 and the distribution unit 38”. Accordingly, the place where the leakage of the ink liquid 30 is generated can be specified.

The alarm can be output by the alarm output section 56, and the serviceman call can be displayed/output as a character image in the display unit 55 with respect to the generation of the serious abnormality indicating the abnormal supply state of the ink liquid 30 or the leakage of the ink liquid 30.

Accordingly, a method of taking measures at the time of the generation of the serious abnormality can be clearly instructed with respect to the user.

For example, a manual or the like in which a method of supplying the ink liquid 30 into the reservoir tank 34 from the ink bottle 31, or a method of supplying the ink liquid 30 into the distribution unit 38 from the reservoir tank 34 is described is distributed to the user beforehand. Then, the user can refer to the manual or the like, and handle the light abnormality by the drop of the liquid surface height of the ink liquid 30.

The present invention is not limited to the above-described embodiments, and may be modified as follows.

For example, the second or fourth management step time M₂ or M₄ may be a time required for monitoring whether or not there is a leakage of the ink liquid 30 or the like in the reservoir tank 34 or the distribution unit 38.

The first and second liquid surface sensors 46, 47 are not limited to the float switches, and water level indicators may be used.

The present invention is not limited to the application to the image forming apparatus of the ink jet system, and is applicable to all apparatuses that manage the state of the ink path for supplying the ink liquid 30.

The display of the light or serious abnormality does not have to be divided into the display lamp 62-1 on the display board 60 and the display 61.

The respective light or serious abnormalities may be displayed in the display 18.

The display color of the display 18 is not limited to one color, and, for example, the use of a color which attracts attentions, such as red, is effective as a display color of the serious abnormality.

Stages of the abnormalities are not limited to two stages of the light and serious abnormalities, and a plurality of stages may be used. For example, three stages of light, medium and serious stages may be set.

1. A management device for a fluid path, comprising:
a first container which contains a fluid;
a second container which contains the fluid;
a fluid supply system which supplies the fluid to the second container from the fluid stored in the first container;
a liquid surface sensor which detects a liquid surface height of the fluid stored in the second container and which outputs liquid surface information of the liquid surface height;
a distinction section which distinguishes at least one of a supply state of the fluid into the second container including the fluid supply system, a state of the second container, or a drop of the liquid surface of the fluid based on the liquid surface information; and
a notification section which issues a distinction result by the distinction section.

2. The management device for the fluid path according to claim 1, further comprising:
the liquid surface sensor which detects the liquid surface height of the fluid stored in the first container and which outputs liquid surface information of the liquid surface height.

3. The management device for the fluid path according to claim 1, wherein the distinction section monitors time until the liquid surface sensor detects the liquid of surface stored in the second container within a first management step time starting from a time of the supply of the fluid simultaneously with the supply of the fluid from the first container to the second container; and judges that an abnormality is generated in the fluid supply system when the liquid surface sensor does not detect the liquid surface within the first management step time by the time monitoring.

4. The management device for the fluid path according to claim 1, wherein the supply of the fluid from the first container into the second container is stopped when the liquid surface is detected by a sensor within the first management step time, and
the distinction section monitors the information of the liquid surface height output from the liquid surface sensor with an elapsed time within a second management step time starting from stopping of the supply of the fluid from the first container into the second container, and judges that an abnormality is generated in a state of the second container, when the information output from the liquid surface sensor is not maintained after the elapsed time of the second management step time by the time monitoring.

5. The management device for the fluid path according to claim 1, having a first management step time starting from a time of the supply of the fluid from the first container into the second container; and having a second management step time starting from a time of stopping supply of the fluid from the first container into the second container,
wherein the distinction section is distinguishing at least one of the supply state of the fluid from the first container into the second container comprising the supply system between the first container and the second container at least one of the state in the second container, and the drop of the liquid surface of the fluid in the second container, and at least two divided abnormality having with first and second stages.

6. The management device for the fluid path according to claim 5, wherein the distinction section distinguishing the first stage of the abnormality, in a case where the fluid stored finishing to the second container is distinguished consumption of the liquid, in a case where the liquid surface sensor does not detect the liquid surface and does not supply with the fluid from the first container into the second container.

7. The management device for the fluid path according to claim 5, wherein the distinction section monitor is a time detects the liquid of surface stored in the second container within the first management step time simultaneously with the supply of the fluid from the first container into the second container, and distinguishes the second stage of the abnormality, when the liquid surface sensor does not detect the liquid surface within the first management step time by the time monitoring.

8. The management device for the fluid path according to claim 5, wherein the supply of the fluid from the first container into the second container is stopped, when the liquid surface is detected by the liquid surface sensor within the first management step time; and
the distinction section monitors a time the liquid surface sensor detects the liquid surface of the fluid stored in the second container within the second management step time, and distinguishes the second stage of the abnormality, when the liquid surface information output from the liquid surface sensor is not maintained after the elapsed time of the second management step time by the time monitoring.

9. The management device for the fluid path according to claim 1, wherein the distinction section distinguishes at least one of the supply state of the fluid from the first container into the second container comprising the supply system between the first container and the second container, the state in second container, the drop of the liquid surface in the second container at least two divided stages of abnormalities having first and second stages; and
the notification section notifies the abnormality at least one of the stages are distinguished by the distinction section.

10. The management device for the fluid path according to claim 9, wherein the distinction section distinguishes the first stage of the abnormality whose factor is consumption of the fluid stored in the second container; from the second stage of the abnormality regarded as generation of the abnormality in the fluid supply system or generation of an abnormal state in the second container based on the liquid surface information output from the liquid surface sensor; and
the notification section displays/outputs at least one of the drop of the liquid surface which is the first stage of the abnormality distinguished by the distinction section and the generation of the abnormality in the fluid supply system and the generation of the abnormal state in the second container which are the second stage of the abnormality.

11. The management device for the fluid path according to claim 10, wherein the notification section are doing the displays/outputs at least one of the generation of the abnormality in the fluid supply system and the generation of the abnormal state in the second container; and with one or both of an alarm and a serviceman call indicating of the at least one of the generation of the abnormality in the fluid supply system or the generation of the abnormal state in the second container.

12. A management device for a fluid path comprising:
an ink bottle which contains an ink liquid;
a reservoir tank into which the ink liquid is supplied from the ink bottle;
a distribution unit which the ink liquid is supplied from the reservoir tank;
an ink head which ejects the ink liquid supplied from the distribution unit;
a first liquid surface sensor which detects a first liquid surface height of the ink liquid stored in the reservoir tank and which outputs information of the first liquid surface height;
a second liquid surface sensor which detects a second liquid surface height of the ink liquid stored in the distribution unit and which outputs information of the second liquid surface height;
a distinction section which distinguishes at least one of: each supply state of the ink liquid including a supply path of the ink liquid into one or both of at least the reservoir tank and the distribution unit; each state of the reservoir tank or the distribution unit; and drops of the first and second liquid surface heights based on, one or both of the first and second liquid surface information; and
a notification section which notifies a distinction result of the distinction section.

13. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
at least one third opening/closing valve which opens the inside of the distribution unit to the atmosphere; and
a first ink supply section which opens the first and second opening/closing valves, and closes the third opening/closing valve to supply the ink liquid to the reservoir tank, is storing to the reservoir tank with the ink liquid from the ink bottle.

14. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
a second piping disposed between the reservoir tank and the distribution unit;
at least one third opening/closing valve which opens the inside of the distribution unit to the atmosphere; and
a second ink supply section which opens the first and third opening/closing valves, and closes the second opening/closing valve to supply the ink liquid to the distribution unit, is storing to the distribution unit with the ink liquid from the reservoir tank.

15. The management device for the fluid path according to claim 12, wherein the distinction section distinguishes one or both of: the drop of the liquid surface height, or generation of abnormal supply of the ink liquid is in one or both of at least the reservoir tank and the distribution unit; and generation of an abnormality is in one or both of the reservoir tank or the distribution unit based one or both of the first liquid surface information output from the first liquid surface sensor or the second liquid surface information output from the second liquid surface sensor.

16. The management device for the fluid path according to claim 15, further comprising:
a first distinction section is distinguishing the supply state of the ink liquid to the reservoir tank and the state of the reservoir tank; and
a second distinction section is distinguishing the supply state of the ink liquid to the distribution unit and the state of the distribution unit.

17. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
at least one third opening/closing valve which opens the inside of the distribution unit to the atmosphere;
a first ink supply section which opens the first and second opening/closing valves, and closes the third opening/closing valve to supply the ink liquid to the reservoir tank, is storing to the reservoir tank with the ink liquid from the ink bottle; and
a first distinction section is monitoring time until the liquid surface the first sensor detects, the first liquid surface height in a first management step time starting from a time of the supply of the ink liquid simultaneously with the supply of the ink liquid by the first supply section is distinguished, and which distinguishes the supply state of the ink liquid to the reservoir tank based on a result of the time monitoring.

18. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
at least one third opening/closing valve which opens the inside of the distribution unit to the atmosphere;
a first ink supply section which closes the first to third opening/closing valves to stop the supply of the ink liquid from the ink bottle to the reservoir tank; and
a first distinction section is monitoring the detection of the first liquid surface height by the first liquid surface sensor, elapses with a second management step time from when the first to third opening/closing valves are closed after the elapsed time of a first management step time starting from a time of the supply of the ink liquid; and the first distinction is doing presence/absence of an abnormality of the state of the reservoir tank based on a result of the time monitoring.

19. The management device for the fluid path according to claim 17, wherein the first distinction section distinguishes the supply state of the ink liquid from the ink bottle to the reservoir tank including the first piping is abnormal, when the first liquid surface sensor does not detect the first liquid surface height within the first management step time at the time of the supply of the ink liquid by the first ink supply section.

20. The management device for the fluid path according to claim 18, wherein the first distinction section monitors the first liquid surface height detected by the first liquid surface sensor, with elapsing the second management step time, and judges that the state of the reservoir tank is abnormal, when the first liquid surface height detected by the first liquid surface sensor is not maintained after the elapsed time of the second management step time.

21. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
a second piping disposed between the reservoir tank and the distribution unit;
at least one third opening/closing valve which opens the inside of the distribution unit to the atmosphere;
a second ink supply section which opens the first and third opening/closing valves, and which closes the second opening/closing valve to supply the ink liquid stored in the reservoir tank to the distribution unit; and
a second distinction section is time monitoring of the second liquid surface height detected by the second liquid surface sensor, with elapsing a third management step time from when the first and third opening/closing valves are opened in a state in which the second opening/closing valve is closed and to distinguish the supply state of the ink liquid to the distribution unit including at least the second piping based on a result of the time monitoring.

22. The management device for the fluid path according to claim 12, further comprising:
a first piping disposed between the ink bottle and the reservoir tank;
at least one first opening/closing valve disposed in the first piping;
at least one second opening/closing valve which opens the inside of the reservoir tank to the atmosphere;
a second piping disposed between the reservoir tank and the distribution unit;
at least one third opening/closing valve which opens the inside of the distribution unit to the atmosphere;
a second ink supply section which closes the first to third opening/closing valves to stop the supply of the ink liquid from the reservoir tank to the distribution unit; and
a second distinction section is time monitoring of the second liquid surface height detected by the second liquid surface sensor, with elapsing a fourth management step time when the first to third opening/closing valves are with closed time after the elapsed time of a third management step time when the first and third opening/closing valves are opened, and which judges presence/absence of an abnormality of the state of the distribution unit based on a result of the time monitoring.

23. The management device for the fluid path according to claim 22, wherein the second ink supply section closes first and third opening/closing valves, after an elapsed time of a preset delay time when the second liquid surface sensor detects the second liquid surface height.

24. The management device for the fluid path according to claim 21, wherein the second distinction section distinguishes that the supply state of the ink liquid from the reservoir tank to the distribution unit including the second piping is abnormal, when the second liquid surface sensor does not detect the second liquid surface height within the third management step time by the second ink supply section of the ink liquid.

25. The management device for the fluid path according to claim 22, wherein the second distinction section monitors the second liquid surface height detected by the second liquid surface sensor; with time elapsing of the fourth management step time; and judges that the state of the distribution unit is abnormal, when the detection of the second liquid surface height is not maintained by the second liquid surface sensor after the elapsed time of the fourth management step time in the time monitoring.

26. The management device for the fluid path according to claim 12, wherein the distinction section has first and second distinction sections,
the first distinction section distinguishes the supply state of the ink liquid from the ink bottle into the reservoir tank, the state of the reservoir tank, or the drop of the first liquid surface height, by at least two divided stages of abnormalities,
the second distinction section distinguishes the state of supply by the ink liquid from the reservoir tank to the distribution unit; and the state of the distribution unit; and the drop of the second liquid surface height; by at least two divided stages of abnormalities, and
the notification section is doing notification by at least one of the abnormality in the two stages of the abnormalities distinguished by the distinction section.

27. The management device for the fluid path according to claim 26, wherein the first distinction section distinguishes; leakage of or clogging with the ink liquid in the first piping including the first opening/closing valve and disposed between the ink bottle and the reservoir tank the leakage of the ink liquid in the reservoir tank or, the drop of the first liquid surface height of the ink bottle as an abnormal supply state of the ink liquid from the ink bottle to the reservoir tank; and
the second distinction section distinguishes; leakage of or clogging with the ink liquid in the second piping disposed between the reservoir tank and the distribution unit the leakage of the ink liquid in the distribution unit or, the drop of the second liquid surface height of the distribution unit as an abnormal supply state of the ink liquid from the reservoir tank to the distribution unit.

28. The management device for the fluid path according to claim 26, wherein the notification section are doing the displays/outputs at least one of generation of the abnormal supply state of the ink liquid, and generation of the abnormality in the reservoir tank or the distribution unit; and also issuing one or both of an alarm or a serviceman call is indicating the generation of at least one of the abnormal supply state of the ink liquid and an abnormal state of the reservoir tank or the distribution unit.

29. The management device for the fluid path according to claim 26, wherein the notification section, includes:
a plurality of notification items indicating the drops of the liquid surface height in at least the reservoir tank and the distribution unit;
a plurality of display lamps disposed corresponding to the respective notification items; and
a notification driving section is with lighting on of the display lamp corresponding to the notification item one or both of at least the reservoir tank and the distribution unit indicating of the drop of the liquid surface height distinguished by the distinction section.

30. The management device for the fluid path according to claim 26, wherein the notification section, includes:
a first memory which stores a plurality of notification items constituted with character information corresponding to the generation of the abnormal supply state of the ink liquid in one or both of at least the reservoir tank or the distribution unit, and generating of the abnormal supply state of the ink liquid in one or both of the at least reservoir tank or the distribution unit;
a display which displays the abnormality; and
a display unit which outputs the notification item corresponding to the abnormality distinguished by the distinction section in the display.

31. The management device for the fluid path according to claim 26, wherein the notification section includes:
a second memory which stores a plurality of driving programs to read of the respective notification items is from a plurality of the notification items in the first memory, and the second memory is doing display/output; and
a control section which has executes the display driving program in accordance with the distinction result of the distinction section to display/output the character information of the notification items in the display.

32. The management device for the fluid path according to claim 30, wherein the respective notification items have character information of serviceman calls.

33. The management device for the fluid path according to claim 28, wherein the notification section has an alarm unit which issues an alarm indicating the abnormal supply state of the ink liquid and the abnormal state of the reservoir tank or the distribution unit.

34. The management device for the fluid path according to claim 30, wherein the display has a liquid crystal display, a plasma display, or a CRT display.
